(19) United States
(12) Patent Application Publication
(10) Pub. No.: US 2026/0311024 A1
(43) Pub. Date: Oct. 8, 2026

(54) RULE BASED PROCESSING OF QUANTUM COMPUTING PROGRAMS

(71) Applicant: Amazon Technologies, Inc., Seattle, WA (US)

(72) Inventors: Yi-Ting Chen, Long Island City, NY (US); Jeffrey Paul Heckey, Seattle, WA (US); Daniela Becker, New York, NY (US); Abraham A. Coull, Brooklyn, NY (US); Ryan Matthew Shaffer, New York, NY (US); Lauren E Capelluto, New York, NY (US); Jacob Feldman, Seattle, WA (US); Vivek Dwivedi, Long Island City, NY (US); Gandhi Ramu, Pleasanton, CA (US); Ramanathan Ramanathan, Seattle, WA (US); Shobhit Srivastava, Seattle, WA (US); Cody Aoan Wang, Seattle, WA (US)

(73) Assignee: Amazon Technologies, Inc., Seattle, WA (US)

(21) Appl. No.: 19/094,582

(22) Filed: Mar. 28, 2025

(51) Int. Cl. G06N 10/60

(52) U.S. Cl. CPC G06N 10/60

(57) ABSTRACT

Methods and apparatus for rule-based processing of quantum computing algorithms are described herein. Features of a quantum processing unit (QPU) may be onboarded to a quantum computing service provider using logical rules that, when executed, generate code used for preparing a quantum computing algorithm for execution on the QPU. For example, using the logical rules may decouple the functionalities of the quantum computing service from the features of QPU device capabilities.

### BACKGROUND

Quantum computing utilizes the laws of quantum physics to process information. Quantum physics is a theory that describes the behavior of reality at the fundamental level. It is currently the only physical theory that is capable of consistently predicting the behavior of microscopic quantum objects (e.g., particles) like photons, molecules, atoms, and electrons.

A quantum computing device is a device that utilizes quantum mechanics to allow one to write, store, process and read out information encoded in quantum states, e.g., the states of quantum objects. A quantum object is a physical object that behaves according to the laws of quantum physics. The state of a physical object is a description of the object at a given time.

In quantum mechanics, the state of a two-level quantum system, or simply, a qubit, is a list of two complex numbers, where the square root of the sum of squared absolute values of the complex numbers (e.g., \sqrt{|x|²+|y|²}) must sum to one. Each of the two complex numbers (e.g., x and y) is called an amplitude, and their respective quasi-probabilities are the squared absolute values of the complex numbers (e.g., |x|² and |y|², respectively). Hence, the square of the absolute value of each complex number corresponds to the probability of event zero or event one happening. A fundamental and counterintuitive difference between a probabilistic bit (e.g., a traditional zero or one bit) and the qubit is that a probabilistic bit represents a lack of information about a two-level classical system, while a qubit contains maximal information about a two-level quantum system.

Quantum computing devices are based on such quantum bits (qubits), which may experience the phenomena of “superposition” and “entanglement.” Superposition allows a quantum system to be in multiple states at the same time. For example, whereas a classical computer is based on bits that are either zero or one, a qubit may be in a superposition state of zero and one until measurement of the qubit, with different measurement outcome probabilities associated with each state. Entanglement is a strong correlation between quantum particles, such that quantum information obtained (e.g., via measurement) about one of the quantum entangled particles enables one to know quantum information for the other entangled quantum particle (e.g., without having to measure the other entangled particle), even if separated by great distances.

There are different types of qubits that may be used in quantum computers, each having different advantages and disadvantages. For example, some quantum computers may include qubits built from superconductors, Rydberg atoms, trapped ions, semiconductors, photons, etc. Each may experience different levels of interference, errors and decoherence. Also, some may be more useful for generating particular types of quantum circuits or quantum algorithms, while others may be more useful for generating other types of quantum circuits or quantum algorithms.

### BRIEF DESCRIPTION OF THE DRAWINGS

FIG. 1 illustrates a service provider network that implements a quantum processing unit (QPU) feature onboarding service and quantum computing service that utilize a rule based quantum program processing, according to some embodiments.

FIG. 2 illustrates a quantum computing service of a service provider network that onboards QPU or QPU features, wherein logical rules are determined that may be used to incorporate the feature into a code, according to some embodiments.

FIG. 3 illustrates a quantum algorithm being prepared for execution on one or more QPUs, wherein logical rules of a rule library may be used to incorporate QPU features into code for preparing a quantum algorithm for execution, according to some embodiments.

FIG. 4 illustrates a language adapter, wherein the language adapter enables a quantum algorithm preparation service to validate a quantum algorithm in a language agnostic form, according to some embodiments.

FIG. 5 illustrates a rule library being used for various validation and compilation passes, according to some embodiments.

FIG. 6 is a flowchart describing onboarding feature of a QPU using logical rules and executing the logical rules to prepare a quantum algorithm for execution on the QPU, according to some embodiments.

FIG. 7 is a block diagram illustrating an example quantum hardware device that may be configured to execute quantum gates between qubits, and to perform readout and reset steps in between execution of said quantum gates, according to some embodiments.

FIG. 8 is a block diagram illustrating an example classical computing device that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof.

### DETAILED DESCRIPTION

The present disclosure relates to processing quantum computing programs using a rule based approach to prepare the quantum computing programs for execution (or post-processing) using one or more quantum processing units (QPUs). For example, a QPU or features of a QPU may be onboarded to a quantum computing service, wherein onboarding enables the QPU or the features of the QPU to be made available for use by the quantum computing service. The quantum computing service may receive quantum computing programs from various sources such as customers of the quantum computing service. Features of a QPU may include types of qubits, connectivities between qubits, available quantum gates, raw measurement, mid-circuit measurement, classically-controlled quantum gates, and future hardware or logical features yet to be developed. The quantum computing service may determine logical rules based on the features of a QPU such that execution of the logical rules incorporates the features into code for preparing a quantum algorithm for execution. Logical rules may enable a quantum algorithm preparation service to not know beforehand what QPU features are available. For example, a logical rule, when executed, may specify a given validation requirement for a QPU specific feature to be utilized. The logical rules may be stored in a rule library, wherein the logical rules may be accessed when a quantum algorithm is being prepared for a given QPU. For example, instead of a software engineer having to rewrite preparation code (e.g., validation code or compilation code) whenever a new feature becomes available on a QPU, the logical rules described herein enable automatic updating of the preparation code to incorporate the new features without requiring the preparation code to be fully rewritten.

Continual development of features of QPUs can make it difficult for a quantum computing service to quickly make the new features of the QPUs available for customers to access. Rapid development of features make it more difficult to keep up. The developed features may include experimental or non-standard features that are not widely used by quantum hardware providers (QHPs) of QPUs utilized by a quantum computing service. Furthermore, features may be developed so rapidly that the time needed to onboard the features may be so long that the features may become obsolete due to even newer features developed. Thus, there is a need to streamline onboarding new features to reduce onboarding time and make features available quickly. The approach described herein may enable streamlined onboarding of features of QPUs and processing of quantum programs. For example, the approach decouples the functionalities of quantum computing services from the definition of device capabilities, wherein the service code may consume and process the capabilities as a standalone piece of data. Functionalities of a quantum computing service may include quantum program verification, validation, compilation, machine-readable code generation, and data distribution. Device capabilities may include features of a QPU such as described above (e.g., number of qubits, connectivities, available gates, raw measurement, mid-circuit measurement, classically-controlled quantum gates, and future hardware or logical features yet to be developed). Features of a QPU may be stored as logical rules and executed as needed in preparing a quantum program or post-processing results of an executed quantum program.

For example, a service provider network may enable customers of the service provider network to access various quantum processing units (QPUs) of various quantum hardware providers (QHPs). The service provider network may connect with QHPs by establishing an edge computing device at the location of the QHPs. The service provider network may also have one or more classical computing devices to further enable customer access to the various QPUs. The classical computing devices may be located at a central location of the service provider network, distributed among locations, or made available via a cloud based service. The classical computing devices may be used to onboard a QPU of a QHP or features of a QPU. Onboarding, for example, enables a QPU or feature of a QPU to be accessible for use to execute, at least in part, quantum programs submitted by customers of the service provider network. For example, a feature of a given QPU may be developed and implemented on the given QPU at the site of the QHP. The feature, for example, may be the ability to use a classical controller to control quantum gates. Note that features may include hardware and logical capabilities of QPUs that have not yet been developed since quantum technology may be rapidly expanding, for example. Since the feature is not yet onboarded to the service provider network, customers of the service provider network may not be able to utilize the feature that is not onboarded for executing the customer's quantum programs. Nevertheless, the service provider network may receive information about the feature that has not been onboarded. Such information may be provided by the QHP of the QPU. The service provider network may determine one or more logical rules that, when executed, incorporates the one or more features into code for preparing a quantum algorithm of a quantum program for execution. The code may reflect QPU capabilities corresponding to the one or more features. Additionally, the QHP may provide the logical rules to be received by the service provider network. The logical rules may be stored in a rule library, wherein the logical rules may be accessed for execution in subsequent steps of preparing a quantum algorithm for execution or post-processing execution results. A feature of a QPU may be said to have been onboarded (e.g., onboarded features) when the logical rules corresponding to the QPU feature are stored in the rule library.

In some embodiments, onboarded features may be accessed and executed for preparation of quantum algorithms for execution of the quantum algorithms. Quantum algorithms may be provided by a customer of the service provider network in addition to an indication of a particular QPU to be used to execute the quantum algorithm. The quantum algorithm and indication of the particular QPU to be used may be provided together. A quantum algorithm may be part of a quantum program that may include several quantum algorithms as well as classical algorithms (e.g., a hybrid quantum algorithm). In some embodiments, a customer may not indicate which QPU or QPUs to use for execution, wherein the service provider network may automatically select or recommend a QPU or QPUs.

In some embodiments, a service provider network may cause one or more logical rules of a rule library to be executed across one or more processors wherein one or more features specific to a QPU is incorporated into a code. The code may be used to prepare a quantum algorithm for execution on the QPU. For example, the code may be used to verify compatibility of the quantum program with onboarded features of the QPU to be used for execution of the quantum program. For example, a compatible quantum program and QPU may indicate that a given QPU includes all the features required for execution of the quantum program. Having determined that a quantum program and QPU are compatible, the service provider may also cause the QPU to execute, at least in part, the quantum program and provide execution results to the customer that provided the quantum program.

In addition, as related to the above and below description, it may be understood that quantum hardware, such as quantum hardware devices, may be used to implement quantum computers, and/or various components of quantum computers (e.g., quantum processing units/cores, routing spaces, magic state distillation factories, other components used to perform logical quantum computations, etc.). For example, a given quantum hardware device may resemble “building blocks” of a quantum computer, such as a grid (e.g., a one-dimensional grid, a two-dimensional grid, etc.) of qubits that may be initialized in various ways in order to form various components of a quantum computer, such as topological quantum codes. Quantum hardware devices may be further configured such that single qubit gates, multi-qubit gates, and/or other operations of quantum circuits may be performed between qubits of the quantum hardware devices (according to a given physical qubit connectivity graph of the quantum hardware device which details which physical qubits are connected to respective other physical qubits via edges). Quantum hardware devices may also comprise and/or be connected to various control devices (e.g., microwave pulse generators, devices for temperature, magnetic, and/or other environmental controls pertaining to local environments of the physical qubits, etc.) that may be used to maintain and/or transform various properties of the qubits and/or other physical components of a given quantum computer (e.g., QPU of a QHP).

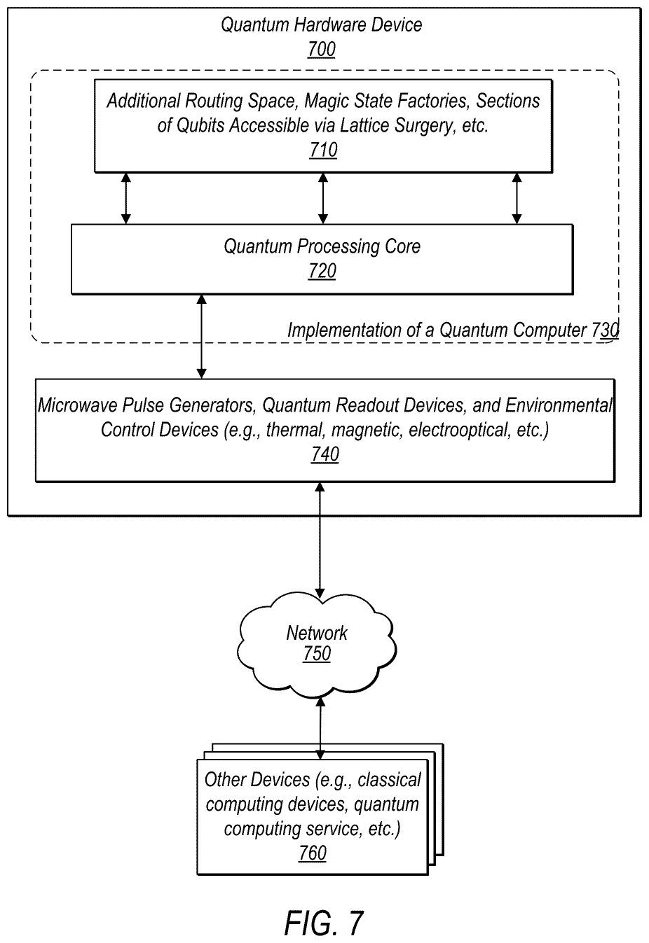

Moreover, as related to the description herein, a qubit may refer to both a logical bit (e.g., a one or a zero with some probability) and to one or more physical components used to construct the given qubit based, at least in part, on the type of qubit technology being applied. It should also be understood that quantum hardware may be used to implement physical qubits that may again be combined in various ways to implement one or more logical qubits such that logical quantum operations may be performed using said physical elements of said quantum hardware. Further examples of interactions between hardware layouts of quantum hardware devices and associated classical measurement and control devices are discussed with regard to at least FIG. 7 herein.

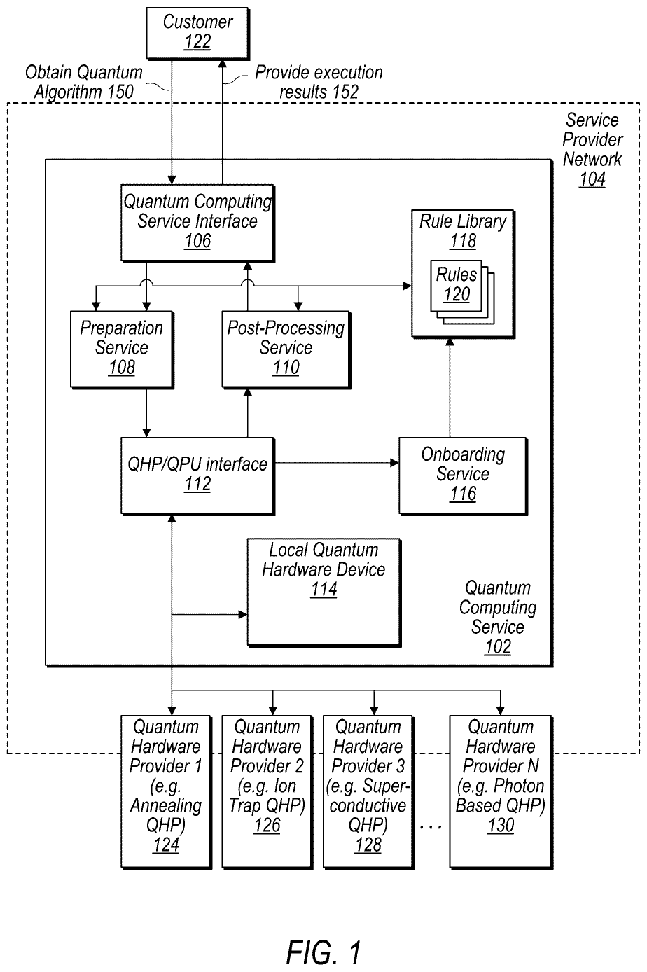

FIG. 1 illustrates a service provider network that implements a quantum processing unit (QPU) feature onboarding service and quantum computing service that utilize a rule based quantum program processing, according to some embodiments.

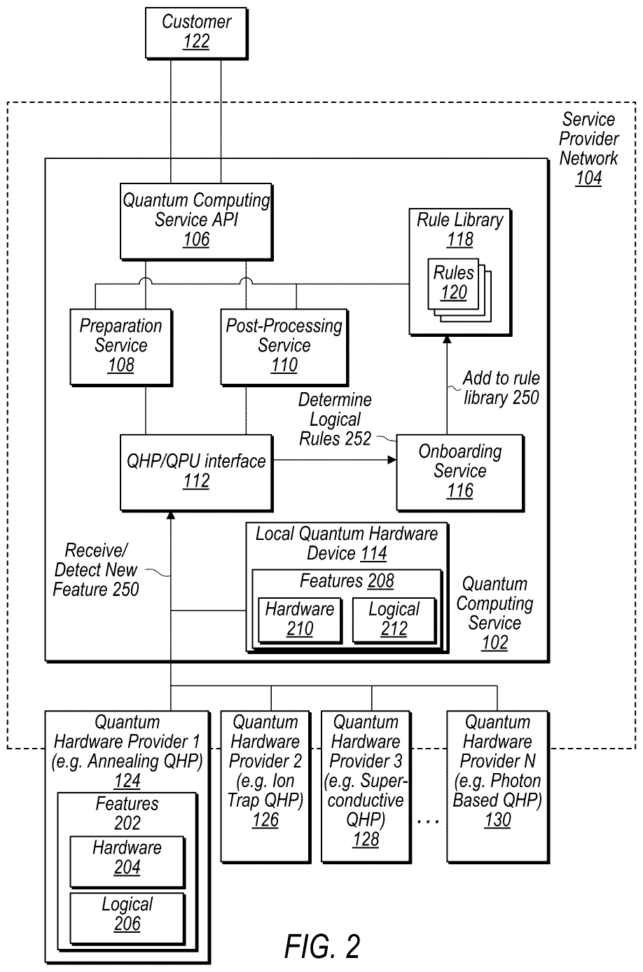

In some embodiments, quantum computing service 102 may be part of service provider network 104, wherein quantum computing service 102 implements a rule based approach to onboarding new QPU features and preparing quantum algorithms for execution on QPUs. Quantum computing service 102 may implement various services for customers of the service with regards to executing quantum algorithms on QPUs of various QHP. For example, quantum computing service 102 enables quantum hardware provider (QHP) 124, 126, 128, and 130 to execute quantum algorithms from customer 122. The various QHPs may each have various QPUs implemented using different quantum devices such as annealing, ion trap, superconductive, and photon based QPUs. Customer 122 may provide a quantum program containing one or more quantum algorithms, wherein quantum computing service interface 106 may obtain quantum algorithm 250. Thus, customer 122 may interact with quantum computing service 102 via quantum computing service interface 106 and utilize the various services provided by quantum computing service 102. One function of quantum computing service 102 may be to prepare and execute the quantum algorithm provided by customer 122. In some embodiments, quantum computing service 102 may onboard available features of QPUs as they come available, for example, to provide customers access to the latest quantum technology features. QHP/QPU interface 112 may interact with QHP 124, 126, 128, and 130 to detect or receive information about availability of QPU features. Onboarding service 116 may determine logical rules to incorporate the QPU feature and store logical rules 120 in rule library 118. See FIG. 2 for an example of onboarding features of a QPU.

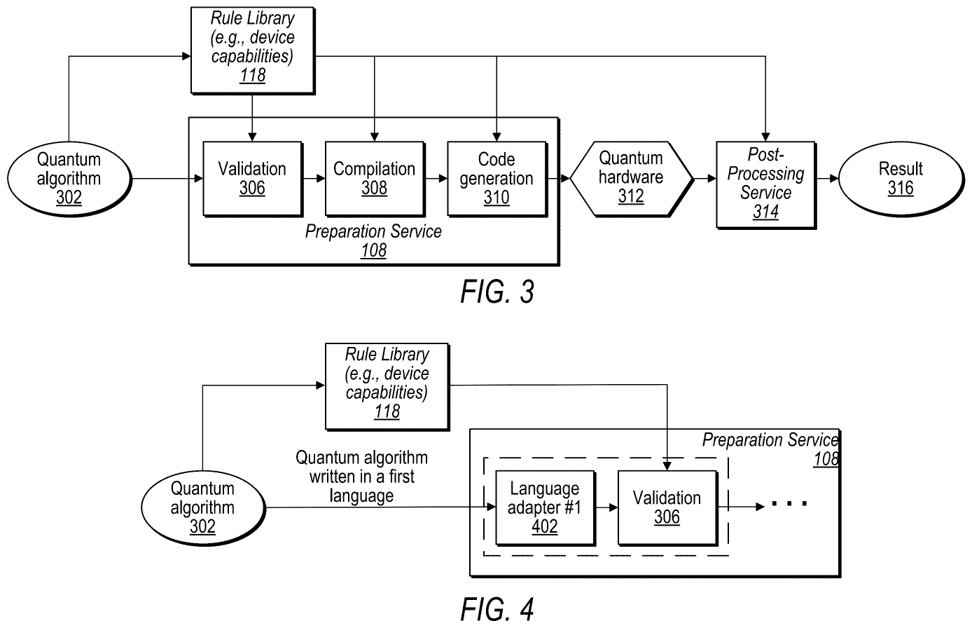

In some embodiments, a quantum algorithm received by quantum computing service interface 106 may enable the quantum algorithm to be prepared for execution via preparation service 108. Preparation service 108 may utilize logical rules 120 of rule library 118 in various ways to prepare a quantum algorithm for execution on QPUs. For example, preparation service may receive, or otherwise obtain, rules to be executed at the preparation service. See FIG. 3-5 for more details of preparation service 108. Execution of the logical rules may incorporate a feature specific to a QPU that the quantum algorithm is to be executed on. For example, execution of the logical rules may integrate the features of the QPU into code that prepares the quantum algorithm for execution. Preparation of the quantum algorithm may include validation, compilation, and machine specific binary code generation among other preparation services that preparation service 108 of quantum computing service 102 may utilize. For example, compatibility of a quantum algorithm with a given QPU may be verified using the code such as described above. Thus, the QPU features may not be known to preparation service 108, however, executing the logical rules incorporates the features of the QPU for quantum code execution.

With a prepared quantum algorithm, quantum computing service may cause the prepared quantum algorithm to be executed. The QPUs used for execution may belong to QHPs 124, 126, 128 or 130 or the QPUs may be local quantum hardware device 114 that is local to quantum computing service 102. Furthermore, results of the execution of quantum algorithms (e.g., execution results) may be obtained by quantum computing service 102, wherein post-processing service 110 may perform one or more post-processing operations to the execution results. Post-processing service 110 may include operations that organize or translate execution results to a specific problem provided by the customer. In some embodiments, executing one or more logical rules at post-processing service 110 may incorporate the features of the QPU into another code, wherein the other code reflect QPU capabilities corresponding to the features of the QPU. In some embodiments, quantum computing service interface 106 may provide execution results 152 to customer 122.

FIG. 2 illustrates a quantum computing service of a service provider network that onboards QPU or QPU features, wherein logical rules are determined that may be used to incorporate the feature into a code, according to some embodiments.

In some embodiments, quantum computing service 102 may onboard a QPU or features of a QPU. For example, QHP 124 may include features 202 corresponding to various hardware 204 and logical 206 features. QHP 124 may implement features that were not previously onboarded to service provider network 104, wherein such features may be onboarded by onboarding service 116. QHP/QPU interface 112 may receive or detect a new feature 250 of quantum hardware provider 124 and route that information to onboarding service 116. Onboarding service 116 may determine logical rules 252 such as described above. Onboarding service 116 may also receive logical rules that were determined by QHP 124. The logical rules may be added to rule library 118 as indicated by add to rule library 250. Rule library 118 may include a number of rules 120 corresponding to the various features available for the various QPUs of the various QHPs. The logical rules, when executed, may incorporate the one or more features of the QPUs into code, wherein the code may be used for preparing a quantum algorithm for execution. For example, the code may reflect QPU capabilities corresponding to the one or more features.

In some embodiments, features 202 may include hardware related features 204 and logical related features 206. For example, a logical capability of a QPU may utilize given hardware in a new logical way to implement a new feature. Furthermore, logical capabilities may include software capabilities that govern hardware or specially designed hardware to implement certain logic operations.

In some embodiments, onboarding service 116 may onboard a new QPU of a given QHP, wherein the new QPU was previously not made available to customers of quantum computing service 102 via quantum computing service 102. Customers may be able to view the various QPUs that are available for use in executing quantum algorithms via quantum computing service interface 106. The onboarded features of a given QPU may be used to execute a quantum algorithm provided by customer 122.

In some embodiments, onboarding features of a given QPU may result in a feature that was previously unavailable to customers of the service provider network 104 to become available to be used to execute quantum programs of customer 122, wherein the given QPU is already made available on service provider network 104. In some embodiments, a feature of the given QPU may become obsolete and no longer supported, wherein the unsupported feature may be removed from quantum computing service 102.

FIG. 3 illustrates a quantum algorithm being prepared for execution on one or more QPUs, wherein logical rules of a rule library may be used to incorporate QPU features into code for preparing a quantum algorithm for execution, according to some embodiments.

In some embodiments, preparation service 108 may perform various operations to prepare quantum algorithm 302 for execution using quantum hardware 312 (e.g., QPU). For example, preparation service 108 may perform validation 306, wherein aspects of quantum algorithm 302 are checked to determine if quantum hardware 312 has each feature necessary to execute quantum algorithm 302. For example, quantum algorithm 302 may require a certain number of qubits and certain quantum gates to be executed. Quantum algorithm 302 may pass validation 306 upon determining that quantum hardware 312 has the necessary features. To determine the features of quantum hardware 312, logical rules of rule library 118 may be executed to reflect QPU capabilities of quantum hardware into code for the validation. For example, the logical rules may replace generic placeholder of a feature (e.g., number of qubits) with the actual feature or capabilities of the QPU.

In some embodiments, preparation service 108 may perform compilation 308, wherein the logical rules enable quantum algorithm 302 to be compiled for quantum hardware 312. Many passes may be used to optimize the compilation of quantum algorithm. In preparing the compilation, logical rules from rule library 118 may be executed to update or generate the compilation to specific device capabilities of quantum hardware 312. Thus, compilation 308 may not have information beforehand about the specific features of quantum hardware 312, but the logical rules of rule library 118 enable that information to be accessible to the code to perform compilation. For example, quantum computing service 102 may compile the quantum program (e.g., quantum algorithm 302) to be executed using quantum hardware 312. Such compilation may be performed using code that reflects quantum hardware 312 capabilities corresponding to the features of quantum hardware 312.

In some embodiments, code generation 310 may prepare quantum algorithm 302 for execution by generating machine-readable code to execute the quantum algorithm 302 on quantum hardware 312. The machine-readable code may be generated according to the code that reflects quantum hardware 312 capabilities. Thus, code generation 310 may not have information beforehand about the specific features of quantum hardware 312, but the logical rules of rule library 118 enable that information to be accessible to the code to generate the machine readable code.

In some embodiments, post-processing service 314 may perform post-processing of quantum algorithm execution results provided by quantum hardware 312. Such post-processing may prepare the execution results to be provided to customer 122. For example, result 316 may include error analysis data along with the execution results, wherein result 316 may be provided to customer 316.

By way of example, quantum hardware 312 (e.g., QPU) may support raw measurement and is made available to customers by quantum computing service 102. A raw measurement instruction may return the raw in-phase and quadrature phase (I-Q) readout value on a qubit instead of a binary 0 or 1. For example, a raw measurement instruction may have the following specification. The input may be a qubit identifier and a readout resonator identifier. The result of the execution of the instructions may return two real numbers for the I-Q readout values. There may only be three qubits of quantum hardware 312 that support the raw measurement instruction. There may be two resonators with respective connectivities with respective qubits. There may be logical rules describing the qubit constraints, logical rules for the return value constraint, and logical rules for the resonator constraint. All of these logical rules relate to features of quantum hardware 312. These logical rules may be chained together to encapsulate all the rules. For validation 306, a validation rule may target the raw measure instructions. To target the raw measure instruction, quantum algorithm 302 may be analyzed to evaluate if quantum algorithm 302 utilizes a raw measurement instruction. In some embodiments, quantum algorithm 302 may take the form of an abstract syntax tree (AST). In response to determining raw measure instruction is utilized, a field may be added to a memory table that indicates the raw measure instruction is indicated by quantum algorithm 302. A validation pass action of validation 306 may be conditioned on whether the corresponding field of the memory table is true. In some embodiments, the pass action may be the only action of the validation pass.

By way of another example, quantum hardware 312 (e.g., QPU) may support mid-circuit measurement (MCM) and classically-controlled (CC) quantum gates. An MCM instruction may provide instructions to measure a qubit and store the result in a register. The result may be made accessible via a key. A CC quantum gate may be applied if a measurement result associated with a provided key indicates that the CC quantum gate is to be applied. MCM and CC quantum gates may be used together and may have the following constraints. A key provided to the CC quantum gate instruction must have a corresponding measurement of a MCM instruction with the same key. Furthermore, there may be a limit to the number of MCM instructions. For example, too many MCM instructions may require a long enough time such that the measurement results may decohere thus losing the significance of the measurement results. The key requirement as well as the maximum number of MCM instructions may be written as logical rules. Furthermore, quantum algorithm 302 may be analyzed to determine whether an MCM instruction is indicated. In some embodiments, quantum algorithm 302 may take the form of an abstract syntax tree (AST). Each time an MCM instruction is detected, a key corresponding to the detected MCM instruction may be stored in a memory table. Each time a CC quantum gate instruction is detected, the CC quantum gate may be recorded in the memory table. An analysis pass for the order between MCM instructions and CC quantum gate instructions may be used to determine if a key relating to an MCM instruction is called before a CC quantum gate instruction with the same key is called. In some embodiments, a validation pass of validation 306 may perform an action that targets the CC quantum gate instructions. An error may be reported, wherein an input MCM key is not in a memory table corresponding to a CC quantum gate instruction. In some embodiments, a pass may be created for the limit on the number of MCM instructions. A first action of the pass may record a number of appearances of MCM instructions in a memory table. The next action of the pass may provide an error if the number of MCM instructions is larger than a limit. Both actions may be executed concurrently or one after the other in any order.

FIG. 4 illustrates a language adapter, wherein the language adapter enables a quantum algorithm preparation service to validate a quantum algorithm in a language agnostic form, according to some embodiments.

In some embodiments, quantum algorithm 302 may be written in a first language, wherein language adapter 402 adapts the quantum algorithm into a language known by quantum computing service 102. Such an adaptation of language may be said to be language agnostic since, for example, any given first language may be utilized by the quantum computing service. For example, quantum algorithm 302 may be in a particular intermediate representation that expresses features to be used in the quantum program. For each type of first language used, there may be a different language adapter 402 to adapt the language to be understood by quantum computing service 102.

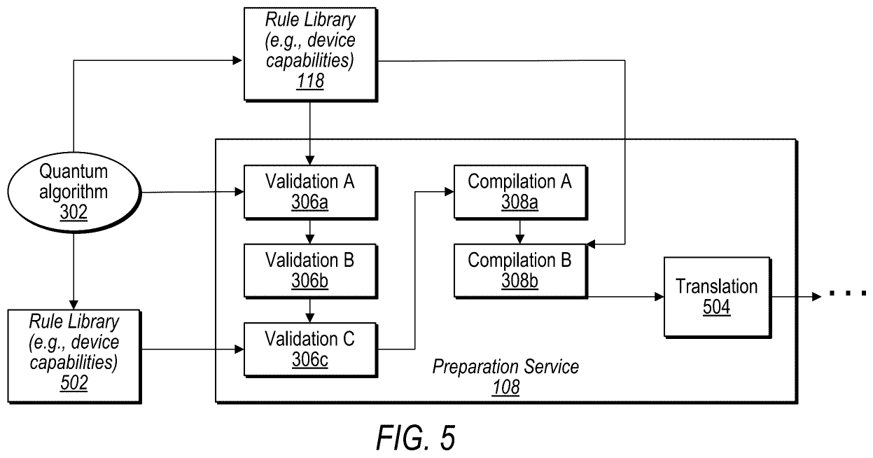

FIG. 5 illustrates a rule library being used for various validation and compilation passes, according to some embodiments.

In some embodiments, there may be several steps for each component of preparation service 108. For example, validation 306 may have validation A, B, and C (respectively 306a, 306b, 306c). A first validation such as validation A 306a may receive quantum algorithm 302 and features indicated to be used for executing quantum algorithm 302 may be detected using rule library 118 and 502, wherein code may be generated for preparing the quantum algorithm for execution. Code, which reflects QPU capabilities, may be generated for use in validation A 306a, validation C 306c, and compilation B 308b. Meanwhile, validation B 306b and compilation A 308a may not need to use logical rules from rule library 118 or 502 since the necessary features may already be hard coded into validation B 306b and compilation A 308a. For example, validation b 306b and compilation A 308a may be widely used standardized steps and not prone to much change if any. Nevertheless, logical rules may be developed for validation B 306b and compilation A 308a.

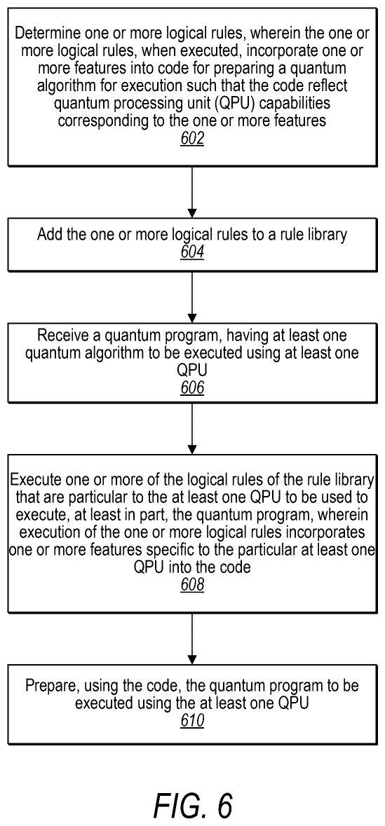

FIG. 6 is a flowchart describing onboarding feature of a QPU using logical rules and executing the logical rules to prepare a quantum algorithm for execution on the QPU, according to some embodiments.

At block 602, quantum computing service 102 may determine one or more logical rules, wherein the one or more logical rules, when executed, incorporate one or more features into code for preparing a quantum algorithm for execution. The code may reflect quantum processing unit (QPU) capabilities corresponding to the one or more features. Logical rules may include a mapping of features of a QPU to the code for preparing a quantum algorithm for execution.

At block 604, quantum computing service 102 may add the one or more logical rules to a rule library. The logical rules may be indexed and accessible for tailored use in preparing code for preparing a quantum algorithm for execution. For example, the entire list of logical rules in the rule library may not be executed, only the portions of logical rules that are specific to a preparation step in preparing the quantum algorithm for execution. Examples of preparation steps include validation, compilation, and machine code generation. Furthermore, the rules may be organized by QPU. For example, a first set of logical rules may correspond to a first QPU and so on. Some logical rules may be applicable to a plurality of QPUs, wherein the plurality of QPUs share a common feature.

At block 606, quantum computing service 102 may receive a quantum program from a customer, wherein the quantum program may have at least one quantum algorithm to be executed using at least one QPU. A quantum program may include one or more quantum algorithms to be executed using at least one QPU and one or more classical algorithms to be executed using at least one classical computing resource. The results of the quantum and classical algorithms may be used together to obtain a result of a quantum program.

At block 608, quantum computing service 102 may execute one or more logical rules of the rule library that are particular to the at least one QPU to be used to execute, at least in part, the quantum program. Such execution of the one or more logical rules may incorporate one or more features specific to the particular at least one QPU into the code. Doing so may enable a preparation service of the quantum computing service 102 to not need to know beforehand what features a particular QPU has.

At block 610, quantum computing service 102 may prepare, using the code, the quantum program to be executed using the at least one QPU. A code may be generated for each feature or for each preparation step used to prepare the quantum program for execution. The prepared quantum program may be executed using the at least one QPU, wherein execution results are provided from the QPU to the quantum computing service. Quantum computing service 102 may perform post-processing before providing, or otherwise making accessible, the execution results to a customer that provided the quantum program.

FIG. 7 is a block diagram illustrating an example quantum hardware device that may be configured to execute quantum gates between superconducting qubits, and to perform readout and reset steps in between execution of said quantum gates, according to some embodiments.

As shown in FIG. 7, a quantum hardware device 700 may comprise one or more central quantum processing units (QPUs) and/or quantum processing cores 720 that, collectively, implement a quantum computer 730. Various configurations of physical qubits may be included in implementation of quantum computer 730 wherein a given subset of a total number of qubits may represent quantum processing core 720 and another given subset of qubits may be used to implement magic state factories, additional routing space, and/or additional quantum processing cores that are accessible via lattice surgery, as shown in block 710. Portions of quantum computations and/or operations may be performed in quantum processing core 720, wherein computationally intensive logical computations may use magic state factories within block 710 in order to produce magic states that may be used to store intermediate computations such that they are held in memory during such quantum computations. In some embodiments, a given magic state factory of block 710 may be merged with quantum processing core 720 during a procedure such as lattice surgery in order for information to pass between such components of the quantum computer.

As related to the description herein, one or more superconducting and/or bosonic qubits within implementation of quantum computer 730 may additionally be coupled to a quantum readout device for measurements of quantum states following performance of one or more quantum gates such as two-qubit entangling gates described herein. The given quantum readout device may be locally connected to various qubits of quantum processing core 720, as shown by interaction arrows to/from block 740.

Depending upon factors such as type(s) of qubit technologies used (e.g., superconducting architectures, bosonic architectures, etc.), type(s) of gates performed between said qubits (e.g., entangling gates, QND measurements), etc., quantum hardware device 700 may also comprise various control devices (e.g., microwave pulse generators, lasers, devices for temperature, magnetic, and/or other environmental controls pertaining to local environments of the grid of qubits within implementation of quantum computer 730, etc.) that may be used to maintain and/or transform various properties of the qubits and/or other physical components of a given quantum computer. For example, a drive may be locally coupled to one or more quantum hardware components within quantum processing core 720, such that various control sequences emitted from said drive may be used to perform readout and/or reinitialize various qubits of quantum processing core 720 into their respective ground states.

In some embodiments in which local environmental control devices 740 include a processor, such as processors 810, local environmental control devices 740 may additionally be configured to interact with other devices 760 via network 750. In some embodiments, other devices 760 may include classical computing devices such as classical computing device 800, which may be configured to interact with quantum hardware device 700 either locally or remotely.

### Illustrative Computer System

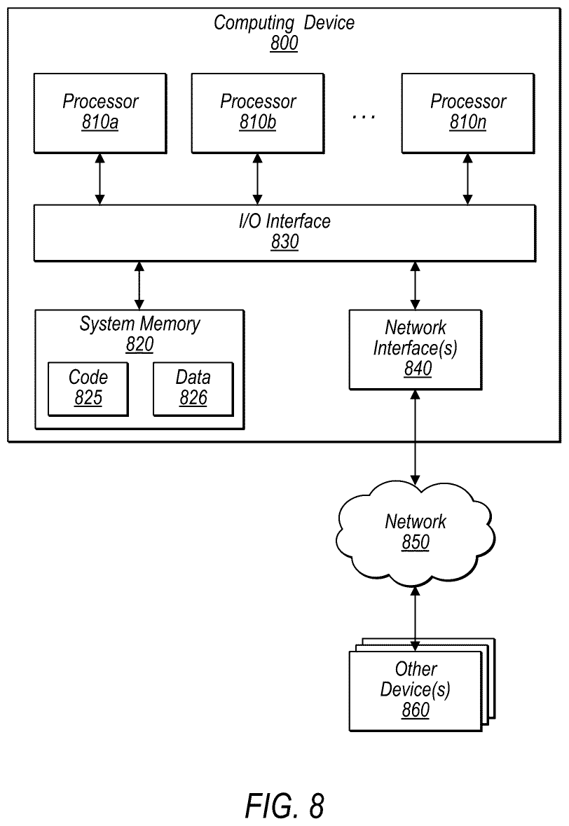

FIG. 8 is a block diagram illustrating an example classical computing device that may be used in at least some embodiments.

FIG. 8 illustrates such a general-purpose classical computing device 800 as may be used in any of the embodiments described herein. In the illustrated embodiment, classical computing device 800 includes one or more processors 810 coupled to a system memory 820 (which may comprise both non-volatile and volatile memory modules) via an input/output (I/O) interface 830. Classical computing device 800 further includes a network interface 840 coupled to I/O interface 830.

In various embodiments, classical computing device 800 may be a uniprocessor system including one processor 810, or a multiprocessor system including several processors 810 (e.g., two, four, eight, or another suitable number). Processors 810 may be any suitable processors capable of executing instructions. For example, in various embodiments, processors 810 may be general-purpose or embedded processors implementing any of a variety of instruction set architectures (ISAs), such as the x86, PowerPC, SPARC, or MIPS ISAs, or any other suitable ISA. In multiprocessor systems, each of processors 810 may commonly, but not necessarily, implement the same ISA. In some implementations, graphics processing units (GPUs) may be used instead of, or in addition to, conventional processors.

System memory 820 may be configured to store instructions and data accessible by processor(s) 810. In at least some embodiments, the system memory 820 may comprise both volatile and non-volatile portions; in other embodiments, only volatile memory may be used. In various embodiments, the volatile portion of system memory 820 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random access memory (ReRAM), three-dimensional NAND technologies, Ferroelectric RAM, magnetoresistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 820 as code 825 and data 826.

In some embodiments, I/O interface 830 may be configured to coordinate I/O traffic between processor 810, system memory 820, and any peripheral devices in the device, including network interface 840 or other peripheral interfaces such as various types of persistent and/or volatile storage devices. In some embodiments, I/O interface 830 may perform any necessary protocol, timing or other data transformations to convert data signals from one component (e.g., system memory 820) into a format suitable for use by another component (e.g., processor 810). In some embodiments, I/O interface 830 may include support for devices attached through various types of peripheral buses, such as a variant of the Peripheral Component Interconnect (PCI) bus standard or the Universal Serial Bus (USB) standard, for example. In some embodiments, the function of I/O interface 830 may be split into two or more separate components, such as a north bridge and a south bridge, for example. Also, in some embodiments some or all of the functionality of I/O interface 830, such as an interface to system memory 820, may be incorporated directly into processor 810.

Network interface 840 may be configured to allow data to be exchanged between classical computing device 800 and other devices 860 attached to a network or networks 850, such as other computer systems or devices as illustrated in FIG. 1 through FIG. 7, for example. In various embodiments, network interface 840 may support communication via any suitable wired or wireless general data networks, such as types of Ethernet network, for example. Additionally, network interface 840 may support communication via telecommunications/telephony networks such as analog voice networks or digital fiber communications networks, via storage area networks such as Fibre Channel SANs, or via any other suitable type of network and/or protocol.

In some embodiments, system memory 820 may represent one embodiment of a computer-accessible medium configured to store at least a subset of program instructions and data used for implementing the methods and apparatus discussed in the context of FIG. 1 through FIG. 7. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to classical computing device 800 via I/O interface 830. A non-transitory computer-accessible storage medium may also include any volatile or non-volatile media such as RAM (e.g., SDRAM, DDR SDRAM, RDRAM, SRAM, etc.), ROM, etc., that may be included in some embodiments of classical computing device 800 as system memory 820 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 840. Portions or all of multiple classical computing devices such as that illustrated in FIG. 8 may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “classical computing device”, as used herein, refers to at least all these types of devices, and is not limited to these types of devices.

### Conclusion

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent exemplary embodiments of methods. The methods may be implemented in software, hardware, or a combination thereof. The order of method may be changed, and various elements may be added, reordered, combined, omitted, modified, etc.

It will also be understood that, although the terms first, second, etc., may be used herein to describe various elements, these elements should not be limited by these terms. These terms are only used to distinguish one element from another. For example, a first item could be termed a second item, and, similarly, a second item could be termed a first item, without departing from the scope of the present invention. The first item and the second item are both items, but they are not the same item.

Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A system, comprising:
a service provider network comprising:
connectivity to one or more quantum hardware providers (QHPs), wherein the service provider network enables quantum processing units (QPUs) of the one or more QHPs to be accessible to one or more customers;
one or more classical computing devices configured to:
onboard one or more features of one or more QPUs of the QHPs, wherein to onboard the one or more features of the one or more QPUs, the one or more classical computing devices are configured to:
receive, from a given QHP, information about the one or more features of the one or more QPUs, wherein a given feature corresponds to one or more hardware capabilities of respective ones of the one or more QPUs;
determine one or more logical rules, wherein the one or more logical rules, when executed, incorporate the one or more features into code for preparing a quantum algorithm for execution such that the code reflects QPU capabilities corresponding to the one or more features;
add the one or more logical rules to a rule library;
receive, from a given customer, a quantum program, having at least one quantum algorithm, and an indication that the one or more QPUs of the given QHP are to be used to execute, at least in part, the quantum program;
execute one or more of the logical rules of the rule library, wherein execution of the one or more logical rules incorporates one or more features specific to the one or more QPUs into the code;
verify, using the code, compatibility of the quantum program to be executed using the one or more QPUs, wherein the quantum program is verified to be compatible in response to a determination that the one or more QPUs includes features required for executing each element of the quantum program;
cause the one or more QPUs to execute, at least in part, the quantum program; and
provide execution results to the given customer.

2. The system of claim 1, wherein the code is a first code and wherein:
the one or more logical rules, when executed, incorporate the one or more features into a second code for post-processing an executed quantum algorithm such that the second code reflect QPU capabilities corresponding to the one or more features.

3. The system of claim 1, wherein the given feature corresponds to one or more logical capabilities of respective ones of the one or more QPUs.

4. The system of claim 1, wherein onboarding the one or more features of the one or more QPUs results in a QPU that was previously unavailable to customers of the service provider network becoming available to be used to execute quantum programs of customers of the service provider network.

5. The system of claim 1, wherein onboarding the one or more features of the one or more QPUs results in a feature that was previously unavailable to customers of the service provider network becoming available for use in executing quantum programs of customers of the service provider network using a given QPU that is already available on the service provider network.

6. The system of claim 1, wherein the one or more classical computing devices are configured to:
compile the quantum program to be executed using the one or more QPU, wherein the compilation is performed using the code that reflects QPU capabilities corresponding to the one or more features.

7. A method, comprising:
determining one or more logical rules, wherein the one or more logical rules, when executed, incorporate one or more features of one or more quantum processing units (QPUs) into code for preparing a quantum algorithm for execution such that the code reflects QPU capabilities corresponding to the one or more features;
adding the one or more logical rules to a rule library;
receiving a quantum program, having at least one quantum algorithm to be executed using at least one QPU;
executing one or more of the logical rules of the rule library that are particular to the at least one QPU to be used to execute, at least in part, the quantum program, wherein execution of the one or more logical rules incorporates one or more features specific to the particular at least one QPU into the code;
preparing, using the code, the quantum program to be executed using the at least one QPU.

8. The method of claim 7, wherein to perform said preparing, using the code, the quantum program to be executed using the at least one QPU, the method comprises:
validating, using the code, compatibility of the quantum program to be executed using the at least one QPU, wherein the quantum program is validated to be compatible in response to a determination that the at least one QPU includes features required for executing each element of the quantum program.

9. The method of claim 7, wherein to perform said preparing, using the code, the quantum program to be executed using the at least one QPU, the method comprises:
compiling, using the code for preparing a quantum algorithm for execution such that the code reflects QPU capabilities corresponding to the one or more features, the quantum program to be executed using the at least one QPU.

10. The method of claim 7, wherein to perform said preparing, using the code, the quantum program to be executed using the at least one QPU, the method comprises:
generating, using the code for preparing a quantum algorithm for execution such that the code reflects QPU capabilities corresponding to the one or more features, machine-readable code to execute the quantum program using the at least one QPU.

11. The method of claim 7, wherein the code is a first code and wherein performing said executing the one or more of the logical rules incorporates the one or more features into a second code for post-processing an executed quantum algorithm such that the second code reflect QPU capabilities corresponding to the one or more features.

12. The method of claim 7, wherein the one or more logical rules, when executed, incorporates the one or more features of the one or more QPUs without a software engineer having to rewrite the code for preparing the quantum program to be executed.

13. The method of claim 7, wherein the one or more logical rules are computing language agnostic.

14. The method of claim 13, comprising:
adapting the received quantum program from a specific quantum programming language to the agnostic computing language of the logical rules.

15. The method of claim 7, comprising:
onboarding one or more features of the one or more QPUs resulting in a feature that was previously unavailable to customers of a service provider network becoming available to be used to execute quantum programs of customers of the service provider network using a given QPU that is already available on the service provider network.

16. The method of claim 1, wherein the given feature corresponds to one or more hardware features or one or more logical capabilities of respective ones of the one or more QPUs.

17. One or more non-transitory computer-readable storage media storing program instructions that, when executed on or across one or more processors, cause the one or more processors to:
determine one or more logical rules, wherein the one or more logical rules, when executed, incorporate one or more features of one or more quantum processing units (QPUs) into code for preparing a quantum algorithm for execution such that the code reflect QPU capabilities corresponding to the one or more features;
add the one or more logical rules to a rule library;
receive a quantum program, having at least one quantum algorithm to be executed using at least one QPU;
execute one or more of the logical rules of the rule library that are particular to the at least one QPU to be used to execute, at least in part, the quantum program, wherein execution of the one or more logical rules incorporates one or more features specific to the particular at least one QPU into the code;
prepare, using the code, the quantum program to be executed using the at least one QPU.

18. The one or more non-transitory computer readable storage media of claim 17, wherein to prepare, using the code, the quantum program to be executed using the at least one QPU, the program instructions, when executed on or across the one or more processors, cause the one or more processors to:
validate, using the code, compatibility of the quantum program to be executed using the at least one QPU, wherein the quantum program is validated to be compatible in response to a determination that the at least one QPU includes features required for executing each element of the quantum program.

19. The one or more non-transitory computer readable storage media of claim 17, wherein to prepare, using the code, the quantum program to be executed using the at least one QPU, the program instructions, when executed on or across the one or more processors, cause the one or more processors to:
compile, using the code for preparing a quantum algorithm for execution such that the code reflect QPU capabilities corresponding to the one or more features, the quantum program to be executed using the at least one QPU.

20. The one or more non-transitory computer readable storage media of claim 17, wherein to prepare, using the code, the quantum program to be executed using the at least one QPU, the program instructions, when executed on or across the one or more processors, cause the one or more processors to:
generate, using the code for preparing a quantum algorithm for execution such that the code reflect QPU capabilities corresponding to the one or more features, machine-readable code to execute the quantum program using the at least one QPU.
